(19) United States
(12) Patent Application Publication
(10) Pub. No.: US 2004/0181480 A1
(43) Pub. Date: Sep. 16, 2004

(54) Systems and methods for managing a financial account based on non-credit behavior of a customer

(76) Inventors: Robert J. Greenberg, Glen Allen, VA (US); Franco D. Harris, Washington, DC (US); Sara H. Kamp Collins, Arlington, VA (US)

Correspondence Address: Finnegan, Henderson, Farabow,, Garrett & Dunner, L.L.P., 1300 I Street, N.W., Washington, DC, 20005-3315, US

(21) Appl. No.: 10/706,952

(22) Filed: Nov. 14, 2003

Related U.S. Application Data
(60) Provisional application No. 60/426,028, filed on Nov. 14, 2002.

(51) Int. Cl. G06F 17/60

(52) U.S. Cl. 705/36

(57) ABSTRACT

Managing a financial account may comprise detecting non-credit behavior of the customer, the non-credit behavior associated with and benefiting an enterprise and determining a reward associated with the financial account based on the detected non-credit behavior. Moreover, managing a financial account may also comprise notifying the customer of the determined reward and evaluating the credit risk of the financial account based upon the frequency at which the non-credit behavior is detected.

### RELATED APPLICATION

Under provisions of 35 U.S.C. § 119(e), this Application claims the benefit of U.S. provisional application No. 60/462,028, filed Nov. 14, 2002, which is incorporated herein by reference.

### DESCRIPTION OF THE INVENTION

1. Field of the Invention

The invention relates generally to systems and methods for managing a financial account, and more particularly, to systems and methods for managing a financial account based on non-credit behavior.

2. Background of the Invention

The use of financial products and systems in the day-to-day lives of most people is continually growing. For example, with the advent and steady growth of electronic commerce, financial products and systems will increasingly be utilized for paying and receiving payment for products and services sold through electronic commerce. In this context, competition between financial institutions and other organizations that provide financial products and systems is ever increasing. Thus the need to create better ways for attracting and retaining customers is a major goal for most providers of financial products and systems.

In an effort to lower operating costs and increase value for its customers, many financial account providers wish to manage financial accounts in such a way as to attract and retain customers. Financial account providers may attract new customers, or may retain current customers, by managing financial accounts in new and different ways. To this end, some financial account providers may offer financial accounts directed toward a customer's particular personal interests, such as a charity supported by the customer or an educational institution previously attended by the customer.

For example, a financial institution may offer a credit card account associated with a particular charity. A basic type of charity card is one in which a percentage of all transactions or purchases made through the account are donated by the credit card issuer to a selected charity. One such charity may be the American Red Cross. In this case, one percent of all transactions involving the credit card may go to the American Red Cross. Generally, this arrangement creates loyalty by the customer to this card. Great inefficiencies are created in this procedure because, for example, the financial account is not managed based on non-credit behavior. Accordingly, efficiently managing a financial account based on non-credit behavior remains an elusive goal.

Thus, there remains a need to efficiently manage a financial account. In addition, there remains a need for managing a financial account based on non-credit behavior.

### SUMMARY OF THE INVENTION

Consistent with embodiments of the present invention, methods and systems for managing a financial account are provided that avoid problems associated with prior methods and systems for managing a financial account as discussed herein above.

In one aspect, a method for managing a financial account for a customer, comprises detecting non-credit behavior of the customer, the non-credit behavior associated with and benefiting an enterprise, determining a reward associated with the financial account based on the detected non-credit behavior, and notifying the customer of the determined reward.

In another aspect, a system for managing a financial account for a customer comprises a component for detecting non-credit behavior of the customer, the non-credit behavior associated with and benefiting an enterprise, a component for determining a reward associated with the financial account based on the detected non-credit behavior, and a component for notifying the customer of the determined reward.

In yet another aspect, a computer-readable medium on which is stored a set of instructions for managing a financial account for a customer, which when executed perform stages comprising detecting non-credit behavior of the customer, the non-credit behavior associated with and benefiting an enterprise, determining a reward associated with the financial account based on the detected non-credit behavior, and notifying the customer of the determined reward.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of an exemplary system for managing a financial account consistent with an embodiment of the present invention;

FIG. 2 is a flow chart of an exemplary method for managing a financial account consistent with an embodiment of the present invention;

FIG. 3A is a flow chart of an exemplary subroutine used in the exemplary method of FIG. 2 for arranging a relationship with an enterprise consistent with an embodiment of the present invention;

FIG. 3B is a flow chart of an exemplary alternative embodiment of the exemplary subroutine of FIG. 3A used in the exemplary method of FIG. 2 for arranging a relationship with an enterprise consistent with an embodiment of the present invention; and

FIG. 4 is a flow chart of an exemplary subroutine used in the exemplary method of FIG. 2 for detecting non-credit behavior of a customer consistent with an embodiment of the present invention.

### DESCRIPTION OF THE EMBODIMENTS

Reference will now be made to various embodiments according to this invention, examples of which are shown in the accompanying drawings and will be obvious from the description of the invention. In the drawings, the same reference numbers represent the same or similar elements in the different drawings whenever possible.

Consistent with the general principles of the present invention, a system for managing a financial account for a customer may comprise a component for detecting non-credit behavior of the customer, the non-credit behavior associated with and benefiting an enterprise, a component for determining a reward associated with the financial account based on the detected non-credit behavior, and a component for notifying the customer of the determined reward. Furthermore, consistent with the general principles of the present invention, a system for managing a financial account of a customer may also include a component for evaluating the credit risk of the financial account and a component for arranging a relationship.

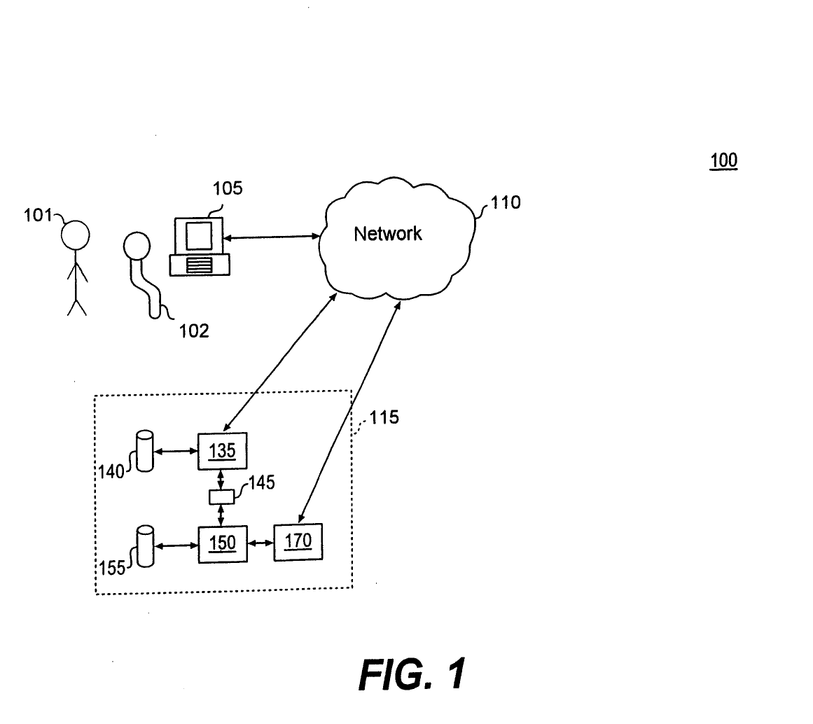

As herein embodied and illustrated in FIG. 1, a financial account managing system 100 may comprise a user computer 105, a network 110, and a financial account management server 115. In the exemplary embodiment of FIG. 1, for example, the component for arranging a relationship, the component for detecting non-credit behavior, the component for determining, the component for notifying the customer, and the component for evaluating the credit risk of the financial account may be embodied in server 115. Those of ordinary skill in the art, however, will appreciate that other elements of system 100 may comprise the component for arranging a relationship, the component for detecting non-credit behavior, the component for determining, the component for notifying the customer, and the component for evaluating the credit risk of the financial account.

User computer 105 may comprise a personal computer or other similar microcomputer-based workstation. Those skilled in the art, however, will appreciate that user computer 105 may comprise any type of computer operating environment such as hand-held devices, multiprocessor systems, microprocessor-based or programmable consumer electronics, minicomputers, mainframe computers, and the like. User computer 105 may also be practiced in distributed computing environments where tasks are performed by remote processing devices. Furthermore, user computer 105 may comprise a mobile terminal such as a smart phone, personal digital assistant (PDA), intelligent pager, portable computer, or a hand held computer. A PDA is a handheld computer that serves as an organizer for personal information. It generally includes at least a name and address database, to-do list and note taker. PDAs are typically pen-based and use a stylus (“pen”) to tap selections on menus and to enter printed characters. The unit may also include a small on-screen keyboard which is tapped with the pen. Data may be synchronized between the PDA and a desktop computer through a cable or wireless transmissions.

User computer 105 may be located in a home, office, store, a retail center kiosk, a remote location, or any location wherein it may be operated. Moreover, user computer 105 may be operated by a user 102 comprising a technician, a member of a charitable organization, a government agent, a school official or volunteer, a civic or professional organization professional or volunteer, or any other person capable of operating user computer 105. Those skilled in the art will appreciate that user computer 105 may be located at a variety of places and operated by a variety of people.

Network 110 may comprise, for example, a local area network (LAN) or a wide area network (WAN). Such networking environments are commonplace in offices, enterprise-wide computer networks, intranets, and the Internet and are known by those skilled in the art. When a LAN is used as network 110, user computer 105 and elements of server 115 are connected to network 110 through a network interface located at each of the respective user computer 105 and elements of server 115. When a WAN networking environment is utilized as network 110, user computer 105 and elements of server 115 typically include an internal or external modem (not shown) or other means for arranging communications over the WAN, such as the Internet.

In addition to utilizing a wire line communications system as network 110, a wireless communications system, or a combination of wire line and wireless may be utilized as network 110 in order to, for example, exchange web pages via the internet, exchange e-mails via the Internet, or for utilizing other communications media.

Wireless can be defined as radio transmission via the airwaves, however, those skilled in the art will appreciate that various other communication techniques can be used to provide wireless transmission including infrared line of sight, cellular, microwave, satellite, packet radio and spread spectrum radio. User computer 105, and elements of server 115 in the wireless environment, can be any mobile terminal such as a smart phone, personal digital assistant (PDA), intelligent pager, portable computer, hand held computer, or any device capable of receiving wireless data. Wireless data may include, but is not limited to, paging, text messaging, e-mail, Internet access and other specialized data applications specifically excluding voice transmission.

In utilizing network 110, data sent over network 110 may be encrypted to insure data security. When encrypting, the data may be converted into a secret code for transmission over a public network. The original file, or “plaintext,” may be converted into a coded equivalent called “ciphertext” via an encryption algorithm executed, for example, on user computer 105 or on elements of server 115. The ciphertext is decoded (decrypted) at a receiving end and turned back into plaintext.

The encryption algorithm may use a key, which is a binary number that is typically from 40 to 128 bits in length. The greater the number of bits in the key (cipher strength), the more possible key combinations and the longer it would take to break the code. The data is encrypted, or “locked,” by combining the bits in the key mathematically with the data bits. At the receiving end, the key is used to “unlock” the code and restore the original data.

There are two main cryptographic methods that may be suitable for use with system 100. The traditional method uses a secret key, such as the Data Encryption Standard (DES). In DES, both sender and receiver use the same key to encrypt and decrypt. This is the fastest method, but transmitting the secret key to the recipient in the first place is not secure. The second method is public-key cryptography, such as the Rivest-Shamir-Adleman (RSA) highly-secure cryptography method by RSA Data Security, Inc., Redwood City, Calif., (www.rsa.com). RSA uses a two-part concept with both a private and a public key. The private key is kept by the owner; the public key is published. Each recipient has a private key that is kept secret and a public key that is published for everyone. The sender looks up the recipient's public key and uses it to encrypt the message. The recipient uses the private key to decrypt the message. Owners never have a need to transmit their private keys to anyone in order to have their messages decrypted, thus the private keys are not in transit and are not vulnerable.

Public key cryptography software marketed under the name Pretty Good Privacy (PGP) from Pretty Good Privacy, Inc., (PGP) of San Mateo, Calif., (www.pqp.com) may be utilized in this embodiment. PGP was developed by Phil Zimmermann, founder of the company, and it is based on the RSA cryptographic method. A version for personal, non-business use is available on various Internet hosts. While PGP may be used to encrypt data transmitted over network 110, those skilled in the art will appreciate that many other types of encryption algorithms, methods and schemes may be employed.

In system 100, data may be transmitted by methods and processes other than, or in combination with network 110. These methods and processes may include, but are not limited to, transferring data via, diskette, CD ROM, facsimile, conventional mail, an interactive voice response system (IVR), or via voice over a publicly switched telephone network. An IVR is an automated telephone answering system that responds with a voice menu and allows the user to make choices and enter information via the telephone keypad. IVR systems are widely used in call centers as well as a replacement for human switchboard operators. An IVR system may also integrate database access and fax response.

Still referring to FIG. 1, server 115 may comprise a first server front end 135 with its associated first server front end database 140, a first server back end 150 with its associated first server back end database 155, and a simple mail transfer protocol (SMTP) server 170. First server front end 135 may be separated from first server back end 150 by a first server firewall 145. One function of first server front end 135 is to provide an interface via network 110 between user computer 105 and server 115. The function of the SMTP server 170 is to provide, for example, an e-mail interface via network 110 between user computer 105 and server 115.

Simple Mail Transfer Protocol is a standard e-mail protocol on the Internet. It is a TCP/IP protocol that defines the message format and the message transfer agent (MTA), which stores and forwards the mail. SMTP was originally designed for only ASCII text, but MIME and other encoding methods enable program and multimedia files to be attached to e-mail messages. SMTP servers route SMTP messages throughout the Internet to a mail server, such as a Post Office Protocol 3 (POP3) or an Internet Messaging Access Protocol (IMAP) server, which provides a message store for incoming mail.

Post Office Protocol 3 (POP3) servers, using the SMTP messaging protocol, are standard mail servers commonly used on the Internet. POP3 servers provide a message store that holds incoming e-mail until users log on and download them. With POP3, all pending messages and attachments are downloaded at the same time. Internet Messaging Access Protocol (IMAP) is also a standard mail server that is widely used on the Internet. It provides a message store that holds incoming e-mail until users log on and download them. IMAP, however, is more sophisticated than the POP3 mail server. In IMAP, messages can be archived in folders, mailboxes can be shared, and a user can access multiple mail servers. There is also better integration with MIME, which is used to attach files. For example, users can read only the headers in the message without having to automatically accept and wait for unwanted attached files to download.

First server front end 135 and first server back end 150 may comprise a personal computer or other similar microcomputer-based workstations. Those skilled in the art, however, will appreciate that first server front end 135 and first server back end 150 may comprise any type of computer operating environment such as hand-held devices, multiprocessor systems, microprocessor-based or programmable consumer electronics, minicomputers, mainframe computers, and the like. First server front end 135 and first server back end 150 may also be practiced in distributed computing environments where tasks are performed by remote processing devices. First server front end 135 may be implemented on a Compaq Proliant 1600 server running Windows 2000 and Domino Webserver. First server back end 150 may be implemented on a Compaq Proliant 1600 server running NT4 and Domino Application Server. And SMTP server 170 may be implemented on a Compaq DL 360 running Windows 2000 and Domino SMTP Mail Server.

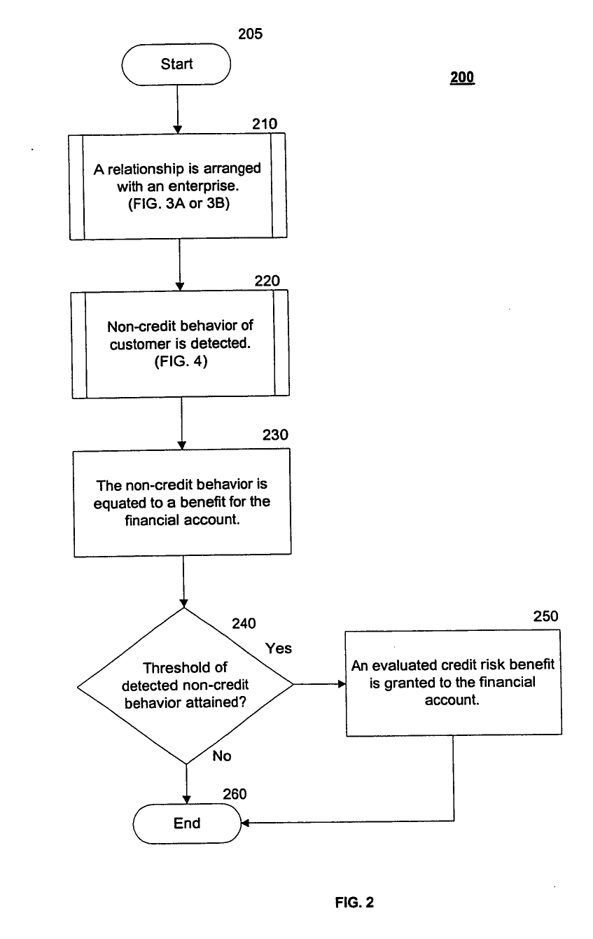

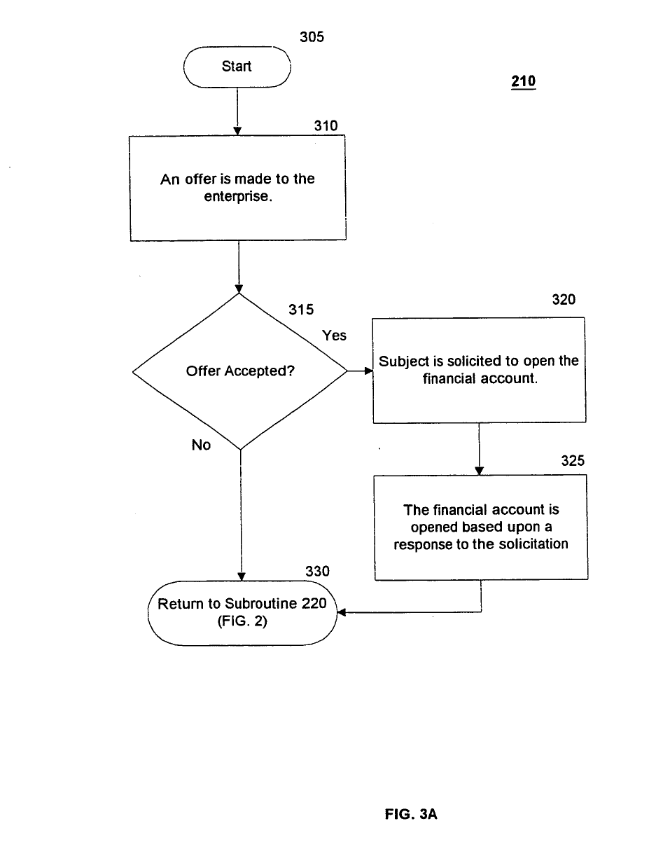

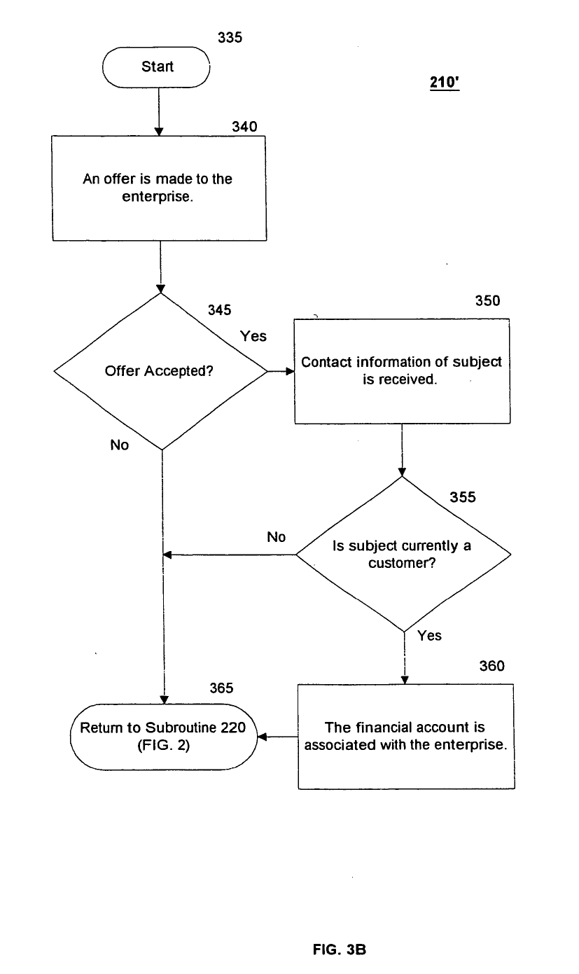

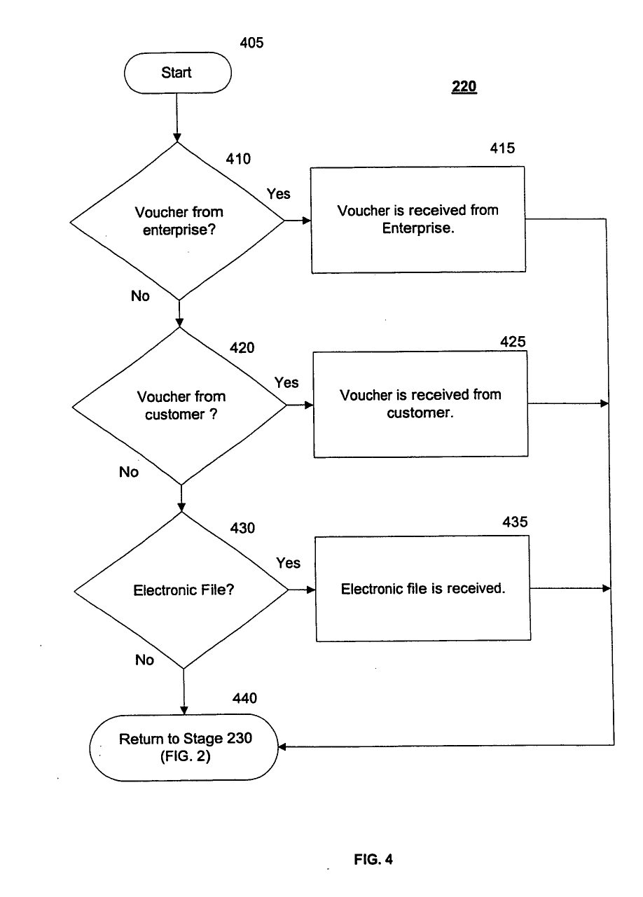

FIG. 2 is a flow chart setting forth the general stages involved in exemplary method for managing a financial account consistent with an embodiment of the present invention. Exemplary ways to implement the stages of method 200 will be described in greater detail below with respect to FIG. 3A through FIG. 4. Exemplary method 200 begins at starting block 205 and proceeds to exemplary subroutine 210 where a relationship is arranged with the enterprise. FIGS. 3A and 3B, described in greater detail below, illustrate exemplary embodiments of subroutine 210 for arranging a relationship with an enterprise.

From exemplary subroutine 210, where a relationship is arranged with the enterprise, exemplary method 200 continues to exemplary subroutine 220 where the non-credit behavior of customer 101 is detected. The stages of exemplary subroutine 220 are shown in FIG. 4 and will be described in greater detail below.

Once the non-credit behavior of customer 101 is detected in exemplary subroutine 220, exemplary method 200 advances to stage 230 where the non-credit behavior is equated to a benefit for the financial account. For example, the enterprise may comprise a Habitat for Humanity house and customer 101 may complete 5 hours of labor for the Habitat for Humanity house or enterprise. Upon receiving a notification of the non-credit behavior associated with customer 101, a financial institution controlling the financial account may provide a benefit to the financial account in response to the non-credit behavior.

The enterprise, for example, may comprise a charity, a religious organization, a civic club, a professional organization, a school, a university, a sports organization, a political organization, a government agency, a private corporation, or a public corporation. Those of ordinary skill in the art will appreciate that other entities may comprise the enterprise. Furthermore, the financial institution controlling the financial account may comprise a bank, a credit card provider, a financial lending institution, a stock brokerage, an insurance company, a government, a utility company, or any other organization controlling financial accounts. Those of ordinary skill in the art will appreciate that other entities may comprise the financial institution controlling the financial account.

Consistent with an embodiment of the present invention, the financial account may comprise a credit card account, a financial loan, a checking account, a savings account, or a stock fund. Those of ordinary skill in the art will appreciate that the financial account may comprise other financial instrument or vehicles. Moreover, the benefit associated with the financial account may comprise a wavier of an annual fee, an interest rate lower than what would have been given if the non-credit behavior had not been performed by customer 101, or a credit limit higher than what would have been given if the non-credit behavior had not been performed by customer 101. Furthermore, the benefit associated with the financial account may not directly effect the financial account. For example, customer 101, or another person or organization designated by customer 101, may receive a monetary credit, a credit redeemable for products, or a credit redeemable for services as the benefit associated with the financial account. For example, the credit redeemable for products or services may comprise a gift certificate or airline frequent flyer miles. Those of ordinary skill in the. art will appreciate that other benefits may be provided to the financial account that directly effect or do not directly effect the financial account.

Specifically, the benefit provided to the financial account may be associated with a separate section or “bucket” to the financial account. After the separate bucket has been created, monetary credits or points comprising, for example, non-monetary credit, may be placed in this bucket. The points may be redeemed for airline frequent flyer miles, for example, or may be redeemed for other products or services.

After the non-credit behavior is equated to the benefit for the financial account in stage 230, exemplary method 200 continues to decision block 240 where it may be determined if the detected non-credit behavior exceeds a threshold criteria. For example, rather than rewarding a certain volume of non-credit behavior, the financial account may reward a certain frequency of non-credit behavior. Specifically, rather than just rewarding for hours worked at a Habitat for Humanity house or for an amount of blood given to the American Red Cross, the threshold criteria may be based on how often (e.g. the number of times in one year) customer 101 attends a Habitat for Humanity building event or participates in a blood drive. In determining the frequency of non-credit behavior, the credit risk of customer 101 associated with the financial account may be evaluated. For example, the greater the frequency of non-credit behavior on behalf of the enterprise, the lower the credit risk associated with customer 101.

If it is determined at decision block 240 that the threshold of the detected non-credit behavior was attained, exemplary method 200 continues to stage 250 where an evaluated credit risk benefit is granted to the financial account. For example, if the threshold is met, the financial account may be granted the evaluated credit risk benefit comprising a wavier of an annual fee, an interest rate lower than the interest rate prior to meeting the threshold, a credit limit higher than the credit limit prior to meeting the threshold, a monetary credit, a credit redeemable for products, or a credit redeemable for services. Those of ordinary skill in the art will appreciate that other benefits may be provided to the financial account.

From stage 250 where the evaluated credit risk benefit is granted to the financial account, or from decision block 240 where it was determined that the threshold of the detected non-credit behavior was not attained, exemplary method 200 ends at stage 260.

FIG. 3A describes exemplary subroutine 210 from FIG. 2 for arranging a relationship with the enterprise. Exemplary subroutine 210 begins at starting block 305 and advances to stage 310 where an offer is made to the enterprise. Consistent with an embodiment of the invention, a financial institution may offer to provide a benefit to the financial account of a customer if the customer engages in a non-credit behavior benefiting the enterprise. In doing so, the financial institution may create customer loyalty between the financial institution and customer 101. In addition, the financial institution may associate a lower credit risk with customers who engage in non-credit behavior and may create general good will by the association and relationship between the enterprise and the financial institution.

From stage 310 where the offer is made to the enterprise, exemplary subroutine 210 continues to decision block 315 where it is determined if the enterprise accepts the offer. For example, upon receiving the offer, the enterprise may evaluate the offer and decide whether the enterprise can gain an advantage by accepting the offer. If so, the enterprise may accept the offer. In addition, in order to reap the greatest benefit, the enterprise may provide a list of its members to the financial institution making the offer. With the member list, the financial institution may create solicitations for financial accounts targeting those listed members, with the solicitations highlighting the arrangement between the enterprise and the financial institution. Specifically, the solicitations may include information relating the specific type of benefit to be credited to the financial account.

If it is determined at decision block 315 that the offer was accepted, exemplary subroutine 210 advances to stage 320 where a subject, comprising a person, for example, is solicited to open the financial account. For example, upon receiving contact information of people involved with the enterprise, the financial institution may solicit all contacts received to open a financial account. By targeting a group of subjects with existing ties with the enterprise, the solicitation may reap a greater percentage of positive responses than if merely the general public was targeted. Notwithstanding, the financial institution may make a general solicitation to subjects comprising the general public the general public noting the relationship with the enterprise. By noting the relationship with the enterprise, the response to the solicitation may be greater than a general solicitation not noting the relationship with the enterprise.

After the subject is solicited to open the financial account in stage 320, exemplary subroutine 210 advances to stage 325 where the financial account is opened based upon a response to the solicitation. For example, upon receiving the solicitation and noting that non-credit behavior benefits the enterprise the subject has a relationship with or otherwise values, the subject may respond positively to the solicitation to become customer 101.

From stage 325 where the financial account is opened based upon a response to the solicitation or from decision block 315 if it was determined that the offer was not accepted, exemplary subroutine 210 continues to stage 330 and returns to exemplary subroutine 220 of FIG. 2.

FIG. 3B describes exemplary subroutine 210′, which is an alternate embodiment of exemplary subroutine 210, for arranging a relationship with the enterprise. Exemplary subroutine 210′ begins at starting block 335 and advances to stage 340 where an offer is made to the enterprise. For example, similar to stage 310 of FIG. 3A, the offer may comprise offering to provide a benefit to the financial accounts of customers in exchange for the customers engaging in non-credit behavior benefiting the enterprise.

From stage 340 where the offer is made to the enterprise, exemplary subroutine 210′ continues to decision block 345 where it is determined if the enterprise accepts the offer. Similar to the decision described above in decision block 315 of FIG. 3A, upon receiving the offer, the enterprise may evaluate the offer and decide whether the enterprise can gain an advantage by accepting the offer. If so, the enterprise may accept the offer. In addition, in order to reap the greatest benefit, the enterprise may include contact information of people involved with the enterprise to the financial institution making the offer.

If it is determined at decision block 345 that the offer was accepted, exemplary subroutine 210′ advances to stage 350 where contact information of the subject is received. For example, the contact information may comprise any data that would enable the financial institution to identify, contact, and solicit customer 101.

Once the contact information of the subject is received in stage 350, exemplary subroutine 210′ continues to decision block 355 where it is determined if the subject is currently a customer of the financial institution. For example, using the contact information provided in stage 350, the financial institution may search its database to determine if the person corresponding to the contact data presently has a financial account with the financial institution.

If it is determined at decision block 355 that the subject is currently a customer, exemplary subroutine 210′ continues to stage 360 where the financial account is associated with the enterprise and the subject becomes customer 101. For example, after searching its database, the financial institution can determine if the subject has a relationship with the enterprise. If so, the financial institution may notify the subject (now customer 101) of the arrangements between the financial institution and the enterprise. Specifically, the financial institution may inform customer 101 that certain non-credit behavior conducted by the customer may result in the financial account being benefited.

From either stage 360 where the financial account is associated with the enterprise, decision block 345 where it was determined that the offer was not accepted, or decision block 355 where it was determined that the subject is not currently a customer, exemplary subroutine 210′ continues to stage 365 and returns to exemplary subroutine 220 of FIG. 2. Notwithstanding, if it was determined that customer 101 is not currently a customer at decision block 355, the subject may be solicited by the financial institution to become a customer as described above with regard to FIG. 3A.

FIG. 4 describes exemplary subroutine 220 from FIG. 2 for detecting a customer's non-credit behavior benefiting the enterprise. Exemplary subroutine 220 begins at starting block 405 and advances to decision block 410 where it is determined if the non-credit behavior is to be detected by receiving a voucher from the enterprise. For example, customer 101 may perform non-credit behavior for the enterprise. Specifically, customer 101 may donate blood to an enterprise such as the American Red Cross. Upon donating the blood, an operator associated with the enterprise, such as user 102, may provide official documentation to the institution controlling the financial account. The official documentation may comprise, for example, a voucher identifying customer 101 as performing the non-credit behavior such as donating blood. The voucher may comprise a paper form that the enterprise validates upon the completion of the non-credit behavior and transfers in paper form or electronically to the financial institution.

In providing the official documentation to the institution controlling the financial account, user 102 may enter the voucher data into user computer 105. From user computer 105, the voucher data may be transferred to server 115, which may be under the control of the institution controlling the financial account, through network 110. In addition to using network 110 to transfer the voucher data to server 115, system 100 may also use e-mail, voice mail, facsimile, mail, an item delivery service, Internet, telephone, diskettes, CD ROM, or an interactive voice response system (IVR). Those of ordinary skill in the art will appreciate that there are many different ways to transfer the voucher data to server 115.

At decision block 410, if it is determined that the non-credit behavior is to be detected by receiving a voucher from the enterprise, exemplary subroutine 220 advances to stage 415 where the voucher is received from the enterprise. For example, once the voucher data is sent, it may then be temporarily stored in database 140 until security checks are performed on the data. Once the security checks are performed, the voucher data may then pass through firewall 145 and stored on database 155. Once the data is in server 115, the financial institution controlling the financial account may utilize the data in equating the non-credit behavior to a benefit for the financial account.

If it is determined at decision block 410, however, that the non-credit behavior is not to be detected by receiving the voucher from the enterprise, exemplary subroutine 220 continues to decision block 420 where it is determined if the non-credit behavior is to be detected by receiving a voucher from customer 101. For example, rather than the operator associated with the enterprise, such as user 102, the voucher data may be transferred by customer 101 performing the non-credit behavior. Other than customer 101, rather than user 102, performing the transfer, the operation of decision block 420 may be the same as decision block 410.

At decision block 420, if it is determined that the non-credit behavior is to be detected by receiving a voucher from customer 101, exemplary subroutine 220 advances to stage 425 where the voucher is received from customer 101. Other than customer 101, rather than user 102, performing the transfer, the operation of stage 425 is the same as stage 415.

If it is determined at decision block 420, however, that the non-credit behavior is not to be detected by receiving the voucher from customer 101, exemplary subroutine 220 continues to decision block 430 where it is determined if the non-credit behavior is to be detected by receiving an electronic file. The electronic file may comprise a description of the non-credit behavior and an identification of the customer. The identification of the customer may be obtained by reading an indicia presented by the customer. For example, rather than creating a voucher, customer 101 or user 102 may more directly document the non-credit behavior of customer 101 electronically. If the financial account comprises a credit card account, for example, an indicia such as the credit card may be scanned or “swiped” by scanning equipment (not shown) attached to user computer 105. Data identifying the credit card account, along with data entered into user computer 105 by customer 101 or user 102 identifying the non-credit behavior, may be augmented and sent as the electronic file to server 115 over network 110. Those of ordinary skill in the art will appreciate that there are many different types of indicia that may be present and many different ways to transfer the electronic file to server 115 including but not limited to e-mail, Internet, diskettes, or CD ROM.

At decision block 430, if it is determined that the non-credit behavior is to be detected by receiving an electronic file, exemplary subroutine 220 advances to stage 435 where the electronic file is received. For example, once the electronic file is sent, it may then be temporarily stored in database 140 until security checks are performed on the data. Once the security checks are performed, the electronic file may then pass through firewall 145 and stored on database 155. Once the electronic file is in server 115, the financial institution controlling the financial account may utilize the electronic file to equate the non-credit behavior to a benefit for the financial account.

From either stage 435 where the electronic file is received, stage 425 where the voucher was received from customer 101, stage 415 where the voucher was received from the enterprise, or decision block 430 where it was determined that the non-credit behavior was not to be detected by receiving an electronic file, exemplary subroutine 220 may continue to stage 440 for returning to stage 230 of FIG. 2.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for managing a financial account for a customer, comprising:
detecting non-credit behavior of the customer, the non-credit behavior associated with and benefiting an enterprise;
determining a reward associated with the financial account based on the detected non-credit behavior; and
notifying the customer of the determined reward.

2. The method of claim 1, further comprising evaluating the credit risk of the financial account based upon the frequency at which the non-credit behavior is detected.

3. The method of claim 2, wherein evaluating the credit risk of the financial account further comprises, if the frequency at which the non-credit behavior is detected attains a certain threshold, providing for the financial account at least one of a wavier of an annual fee, an interest rate lower than the interest rate prior to the evaluation, a credit limit higher than the credit limit prior to the evaluation, a monetary credit, a credit redeemable for products, and a credit redeemable for services.

4. The method of claim 1, further comprising arranging a relationship with the enterprise.

5. The method of claim 4, wherein arranging the relationship with the enterprise further comprises:
making an offer to the enterprise, the offer comprising offering to provide the benefit to the financial account in exchange for the customer engaging in the non-credit behavior;
receiving an acceptance of the offer from the enterprise, the acceptance including contact information of the customer;
soliciting the customer to open the financial account based upon the contact information; and
opening the financial account based upon a response to the solicitation.

6. The method of claim 5, wherein arranging the relationship with the enterprise further comprises providing for the financial account at least one of a wavier of an annual fee, an interest rate lower than what would have been given if the acceptance of the offer had not been received from the enterprise, a credit limit higher than what would have been given if the acceptance of the offer had not been received from the enterprise, a monetary credit, a credit redeemable for products, and a credit redeemable for services.

7. The method of claim 4, wherein arranging the relationship with the enterprise further comprises:
making an offer to the enterprise, the offer comprising offering to provide the benefit to the financial account in exchange for the customer engaging in the non-credit behavior;
receiving an acceptance of the offer from the enterprise, the acceptance including contact information of the customer; and
associating the financial account with the enterprise if the customer is currently a customer of an institution controlling the financial account based upon the contact information.

8. The method of claim 1, wherein detecting the non-credit behavior of the customer further comprises receiving a voucher subsequent to the performance of the non-credit behavior.

9. The method of claim 8, wherein detecting the non-credit behavior of the customer further comprises receiving the voucher from the enterprise.

10. The method of claim 8, wherein detecting the non-credit behavior of the customer further comprises receiving the voucher from the customer.

11. The method of claim 1, wherein detecting the non-credit behavior of the customer further comprises receiving an electronic file subsequent to the performance of the non-credit behavior, the electronic file comprising a description of the non-credit behavior and an identification of the customer, the identification of the customer obtained by reading an indicia presented by the customer.

12. The method of claim 1, wherein determining the reward further comprises providing for the financial account based upon the non-credit behavior at least one of a wavier of an annual fee, an interest rate lower than what would have been given if the non-credit behavior had not been performed by the customer, a credit limit higher than what would have been given if the non-credit behavior had not been performed by the customer, a monetary credit, a credit redeemable for products, and a credit redeemable for services.

13. The method of claim 1, wherein detecting the non-credit behavior of the customer further comprises using at least one of e-mail, voice mail, facsimile, mail, an item delivery service, Internet, telephone, diskettes, CD ROM, and an interactive voice response system (IVR).

14. The method of claim 1, wherein the financial account comprises at least one of a credit card account, a financial loan, a checking account, a savings account, and a stock fund.

15. The method of claim 1, wherein the enterprise comprises at least on of a charity, a religious organization, a civic club, a professional organization, a school, a university, a sports organization, a political organization, a government agency, a private corporation, and a public corporation.

16. A system for managing a financial account for a customer, comprising:
a component for detecting non-credit behavior of the customer, the non-credit behavior associated with and benefiting an enterprise;
a component for determining a reward associated with the financial account based on the detected non-credit behavior; and
a component for notifying the customer of the determined reward.

17. The system of claim 16, further comprising a component for evaluating the credit risk of the financial account based upon the frequency at which the non-credit behavior is detected.

18. The system of claim 17, wherein the component for evaluating the credit risk of the financial account is further configured for, if the frequency at which the non-credit behavior is detected attains a certain threshold, providing for the financial account at least one of a wavier of an annual fee, an interest rate lower than the interest rate prior to the evaluation, a credit limit higher than the credit limit prior to the evaluation, a monetary credit, a credit redeemable for products, and a credit redeemable for services.

19. The method of claim 16, further comprising a component for arranging a relationship with the enterprise.

20. The system of claim 19, wherein the component for arranging the relationship with the enterprise is further configured for:
making an offer to the enterprise, the offer comprising offering to provide the benefit to the financial account in exchange for the customer engaging in the non-credit behavior;
receiving an acceptance of the offer from the enterprise, the acceptance including contact information of the customer;
soliciting the customer to open the financial account based upon the contact information; and
opening the financial account based upon a response to the solicitation.

21. The system of claim 20, wherein the component for arranging the relationship with the enterprise is further configured for providing for the financial account at least one of a wavier of an annual fee, an interest rate lower than what would have been given if the acceptance of the offer had not been received from the enterprise, a credit limit higher than what would have been given if the acceptance of the offer had not been received from the enterprise, a monetary credit, a credit redeemable for products, and a credit redeemable for services.

22. The system of claim 19, wherein the component for arranging the relationship with the enterprise is further configured for:
making an offer to the enterprise, the offer comprising offering to provide the benefit to the financial account in exchange for the customer engaging in the non-credit behavior;
receiving an acceptance of the offer from the enterprise, the acceptance including contact information of the customer; and
associating the financial account with the enterprise if the customer is currently a customer of an institution controlling the financial account based upon the contact information.

23. The system of claim 16, wherein the component for detecting the non-credit behavior of the customer is further configured for receiving a voucher subsequent to the performance of the non-credit behavior.

24. The system of claim 23, wherein the component for detecting the non-credit behavior of the customer is further configured for receiving the voucher from the enterprise.

25. The system of claim 23, wherein the component for detecting the non-credit behavior of the customer is further configured for receiving the voucher from the customer.

26. The system of claim 16, wherein the component for detecting the non-credit behavior of the customer is further configured for receiving an electronic file subsequent to the performance of the non-credit behavior, the electronic file comprising a description of the non-credit behavior and an identification of the customer, the identification of the customer obtained by reading an indicia presented by the customer.

27. The system of claim 16, wherein the component for determining the reward is further configured for providing for the financial account based upon the non-credit behavior at least one of a wavier of an annual fee, an interest rate lower than what would have been given if the non-credit behavior had not been performed by the customer, a credit limit higher than what would have been given if the non-credit behavior had not been performed by the customer, a monetary credit, a credit redeemable for products, and a credit redeemable for services.

28. The system of claim 16, wherein the component for detecting the non-credit behavior of the customer is further configured for using at least one of e-mail, voice mail, facsimile, mail, an item delivery service, Internet, telephone, diskettes, CD ROM, and an interactive voice response system (IVR).

29. The system of claim 16, wherein the financial account comprises at least one of a credit card account, a financial loan, a checking account, a savings account, and a stock fund.

30. The system of claim 16, wherein the enterprise comprises at least on of a charity, a religious organization, a civic club, a professional organization, a school, a university, a sports organization, a political organization, a government agency, a private corporation, and a public corporation.

31. A computer-readable medium on which is stored a set of instructions for managing a financial account for a customer, which when executed perform stages comprising:
detecting non-credit behavior of the customer, the non-credit behavior associated with and benefiting an enterprise;
determining a reward associated with the financial account based on the detected non-credit behavior; and
notifying the customer of the determined reward.

32. The computer-readable medium of claim 31, further comprising evaluating the credit risk of the financial account based upon the frequency at which the non-credit behavior is detected.

33. The computer-readable medium of claim 32, wherein evaluating the credit risk of the financial account further comprises, if the frequency at which the non-credit behavior is detected attains a certain threshold, providing for the financial account at least one of a wavier of an annual fee, an interest rate lower than the interest rate prior to the evaluation, a credit limit higher than the credit limit prior to the evaluation, a monetary credit, a credit redeemable for products, and a credit redeemable for services.

34. The computer-readable medium of claim 31, further comprising arranging a relationship with the enterprise.

35. The computer-readable medium of claim 34, wherein arranging the relationship with the enterprise further comprises:
making an offer to the enterprise, the offer comprising offering to provide the benefit to the financial account in exchange for the customer engaging in the non-credit behavior;
receiving an acceptance of the offer from the enterprise, the acceptance including contact information of the customer;
soliciting the customer to open the financial account based upon the contact information; and
opening the financial account based upon a response to the solicitation.

36. The computer-readable medium of claim 35, wherein arranging the relationship with the enterprise further comprises providing for the financial account at least one of a wavier of an annual fee, an interest rate lower than what would have, been given if the acceptance of the offer had not been received from the enterprise, a credit limit higher than what would have been given if the acceptance of the offer had not been received from the enterprise, a monetary credit, a credit redeemable for products, and a credit redeemable for services.

37. The computer-readable medium of claim 34, wherein arranging the relationship with the enterprise further comprises:
making an offer to the enterprise, the offer comprising offering to provide the benefit to the financial account in exchange for the customer engaging in the non-credit behavior;
receiving an acceptance of the offer from the enterprise, the acceptance including contact information of the customer; and
associating the financial account with the enterprise if the customer is currently a customer of an institution controlling the financial account based upon the contact information.

38. The computer-readable medium of claim 31, wherein detecting the non-credit behavior of the customer further comprises receiving a voucher subsequent to the performance of the non-credit behavior.

39. The computer-readable medium of claim 38, wherein detecting the non-credit behavior of the customer further comprises receiving the voucher from the enterprise.

40. The computer-readable medium of claim 38, wherein detecting the non-credit behavior of the customer further comprises receiving the voucher from the customer.

41. The computer-readable medium of claim 31, wherein detecting the non-credit behavior of the customer further comprises receiving an electronic file subsequent to the performance of the non-credit behavior, the electronic file comprising a description of the non-credit behavior and an identification of the customer, the identification of the customer obtained by reading an indicia presented by the customer.

42. The computer-readable medium of claim 31, wherein determining the reward further comprises providing for the financial account based upon the non-credit behavior at least one of a wavier of an annual fee, an interest rate lower than what would have been given if the non-credit behavior had not been performed by the customer, a credit limit higher than what would have been given if the non-credit behavior had not been performed by the customer, a monetary credit, a credit redeemable for products, and a credit redeemable for services.

43. The computer-readable medium of claim 31, wherein detecting the non-credit behavior of the customer further comprises using at least one of e-mail, voice mail, facsimile, mail, an item delivery service, Internet, telephone, diskettes, CD ROM, and an interactive voice response system (IVR).

44. The computer-readable medium of claim 31, wherein the financial account comprises at least one of a credit card account, a financial loan, a checking account, a savings account, and a stock fund.

45. The computer-readable medium of claim 31, wherein the enterprise comprises at least on of a charity, a religious organization, a civic club, a professional organization, a school, a university, a sports organization, a political organization, a government agency, a private corporation, and a public corporation.
